(19) United States
(12) Patent Application Publication
(10) Pub. No.: US 2009/0218495 A1
(43) Pub. Date: Sep. 3, 2009

(54) Device and Method for Discriminating Cernkov and Scintillation Radiation

(75) Inventors: Thierry Leroux, Caen (FR); Pierre Boher, Ver Sur Mer (FR)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Eldim SA, Herouville Saint Clair (FR)

(21) Appl. No.: 12/300,956

(22) PCT Filed: May 15, 2007
(86) PCT No.: PCT/EP2007/004310

§ 371 Date: Apr. 29, 2009

(30) Foreign Application Priority Data
May 15, 2006 (EP) 0629079737

(51) Int. Cl. G01T 1/20; G06K 9/00

(52) U.S. Cl. 250/362; 250/361 R; 250/370.11; 382/132

(57) ABSTRACT

A device for discriminating Cerenkov and scintillation radiation and a beam inspection device, including an inspection head comprising a scintillator and at least one ionizing radiation diffuser block, a device for discriminating Cerenkov and scintillation radiation, and an imaging system for forming an image from at least a part of the inspection head, along with a corresponding method. In order to suppress spurious Cerenkov radiation contributions to the scintillation radiation, the device has periodically arranged first and second filters, having different relative absorption properties with respect to scintillation radiation and ionizing radiation. Also, an imaging apparatus comprising means for reducing parasitic contributions to a signal of interest, wherein the apparatus has a modulation mask for modulating a signal of interest, wherein, in particular, the signal of interest is the signal illuminating the object or the signal emitted or reflected from the object, and an image analyzing means configured to remove—at least partially—parasitic contributions added to the modulated signal of interest based on the shift of the signal of interest towards higher frequencies due to the modulation.

### CROSS-REFERENCE TO RELATED APPLICATION

The present application claims the benefit of priority of International Patent Application No. PCT/EP2007/004310, filed May 15, 2007 which application claims priority of European Patent Application No. 06290797.7, filed May 15, 2006. The entire text of the priority application is incorporated herein by reference in its entirety.

### FIELD OF THE DISCLOSURE

The disclosure relates to a device for discriminating Cerenkov and scintillation radiation and a beam inspection device comprising the same, a method for discriminating Cerenkov and scintillation radiation using a discriminating device or a beam inspection device, an imaging apparatus capable of reducing parasitic contributions to the image and a corresponding method, and to inspecting ionizing beams, particularly in the field of the adjustment and control of medical equipment such as radiotherapy devices.

### BACKGROUND

In radiotherapy, ionizing radiation, such as X-ray, β, or γ radiation, is used to destroy tumor cells of a patient. During the irradiation of the cancerous tissues, it is, however, unavoidable to expose healthy tissue at the same time. To optimize the radiation dose, the propagation of the radiation is modeled. As, however, the radiation dose to which a patient is going to be exposed depends on many different parameters such as wavelengths used, intensity or beam directions, the model calculations are supported by beam inspection devices which analyze the dose distribution of an ionizing radiation source in a phantom modeled a patient.

Various types of beam inspection devices, also called dosimeters, are known in the art. Commonly used dosimeters work with scintillators to measure the irradiation dose. In the scintillator, the radiation dose received is transformed into light which is then detected by conventional means.

US 2004-0178361 discloses such a device and method for inspecting an ionizing radiation beam. Such a device comprises an inspection head comprising a scintillator plate and at least one ionizing radiation diffuser block connected to the scintillator. Furthermore, means are provided for forming an image of the inspection head. The dose profile and/or depth dose of the beam can then be determined from the signal obtained by the imaging means. Such a device allows a 2D and 3D analysis of the ionizing radiation beam. Similar devices using scintillators are known from US 2004-0238749, U.S. Pat. No. 6,998,604 and U.S. Pat. No. 6,594,336.

Devices comprising scintillators suffer from the problem that not only light created by the scintillator based on the ionizing radiation provided by a radiation source is detected, but also parasitic Cerenkov light, created in the diffuser block of the inspection head is collected by the imaging system, so that the measured intensity does not reflect the radiation dose. To overcome this problem, so far, it is has been proposed to use scintillation radiation of a wavelength region in which the Cerenkov radiation is less important—Cerenkov radiation has an inverse square of the wavelength proportionality—in combination with filters.

US 2004-0238749 discloses to use an optical fiber and two different filters to calculate the quantity of Cerenkov radiation in the measured intensity. US 2004-0178361 discloses the use of a plurality of different filters and to take for each filter a different image. These discrimination solutions are nevertheless still not satisfying.

In the US 2004-0238749, the 2D or 3D measurements cannot be carried out and the solution of the US 2004-0178361 needs a plurality of images to enable the discrimination between Cerenkov radiation and scintillation radiation.

### SUMMARY OF THE DISCLOSURE

Starting therefrom, it is therefore the object of the present disclosure to provide a device for discriminating Cerenkov and scintillation radiation and/or a beam inspection device allowing 2D/3D dosimetry without having to use a plurality of images. It is also the object of the present disclosure to provide a corresponding method for discriminating Cerenkov and scintillation radiation.

Besides that the disclosure is also applicable for other situations in which parasitic light perturbates the image of an object. Such parasitic contributions may have various origins besides the Cerenkov radiation problem described above for dosimeter applications.

It is therefore a second object of the present disclosure to provide an imaging apparatus capable of reducing parasitic contributions from an image of an object and a corresponding method.

In this context, Cerenkov radiation corresponds to parasitic radiation and which is associated with charged atomic particles moving at velocities higher than the speed of light in the local medium. The charged particles are created by the ionising radiation. In the beam inspection devices or dosimeters, the Cerenkov radiation is created in the scintillator and/or the diffuser block. Cerenkov radiation emits under all angles and at all frequencies in the visible spectrum, when it occurs in an optically transparent medium. The energy per unit wavelength of the Cerenkov radiation is proportional to the inverse square of the wavelength.

Furthermore, in this context, scintillator radiation is attributed to the radiation provided by the scintillator which can be a part of a beam inspection device or dosimeter. The spectrum of the scintillator radiation depends on the scintillator material used. The term “ionizing radiation” relates to radiation of high energy, such as X, β, or γ radiation which is for example provided by an accelerator.

Due to the fact that the absorption properties for the two different kinds of filters are different concerning the two types of radiation, and due to the fact that the filters are regularly arranged, the radiation having passed the filters will present a spatially modulated amplitude, the properties of which can be exploited to extract the scintillation radiation intensity from the ionizing radiation and as a consequence from the spurious Cerenkov radiation contribution. As the necessary modulation information can be obtained by analyzing the spatial intensity distribution of radiation having past the two types of filters, it is furthermore sufficient to take only one image.

Preferably, the first filters can be transparent and the second filters opaque to scintillation radiation. This facilitates the extraction of the scintillation radiation signal out of the measured intensity modulation.

According to a preferable embodiment, the first and second filter can be both transparent to the ionizing radiation. In this case, in each point of an image taken of a radiation beam comprising scintillation radiation which has passed the first and second filters, and which correspond to the position of the first filter, the light intensity is the sum of two contributions: the scintillation radiation and Cerenkov radiation created as a consequence of the ionizing radiation which has passed the inventive device. In contrast thereto, each point of the image corresponding to the second filters has a unique contribution, which is the light intensity arising from Cerenkov radiation only (which again is the consequence of ionizing radiation having passed the second filters). This clear attribution to the two types of radiation makes the analysis even simpler and therefore the extraction of the scintillation radiation is improved.

Preferably, the first and second filters are arranged in the form of a checkerboard. Such an arrangement of the first and second filters allows the discrimination between Cerenkov radiation and scintillation radiation in two dimensions.

Advantageously, the device for discriminating Cerenkov and scintillation radiation can comprise a first layer, in particular a plastic sheet, more specifically a polystyrene Plexiglas sheet, and a second layer comprising regions forming the second filters. Such a structure is easy to realize and therefore cost effective. In fact, the first layer will form the first filters in those regions where the second filters are not present.

Preferably, the regions can be square formed having the advantage that the signal modulation dependency will be the same in the two dimensions.

According to a preferred embodiment, the regions can be made out of black ink. Black ink has the desired properties of being opaque to scintillation radiation, but being transparent to higher energy ionizing radiation. Furthermore, using standard printing technology, the periodically arranged regions can be easily realized.

According to an advantageous embodiment, the device for discriminating Cerenkov and scintillation radiation can further comprise a signal analyzing means configured to extract the scintillation radiation contribution out of a signal comprising scintillation and Cerenkov radiation, in particular based on a Fourier transform algorithm. Due to the fact that the first and second filters are periodically arranged, the properties of Fourier transformation can be advantageously applied. Indeed, the amplitude of the signal modulation between the first and second filters can be deduced in each point of the image, wherein the modulation amplitude will correspond to the scintillation light intensity cleared from the Cerenkov contribution in case the first and second filters are transparent to ionizing radiation, whereas the first filter is transparent to scintillation radiation but the second filter opaque to scintillation radiation.

The disclosure also relates to a beam inspection device according to claim 9. The device for discriminating Cerenkov and scintillation radiation as described above being part of the beam inspection device, the same advantageous effect can be obtained.

Preferably the device for discriminating Cerenkov and scintillation radiation can be positioned between the scintillator and the imaging system. Thus, the imaging system detects the modulated intensity in case the beam inspection device is irradiated with ionizing radiation.

Preferably, the device for discriminating Cerenkov and scintillation radiation can be positioned between the scintillator and the ionizing radiation diffuser block, arranged between the scintillator and the imaging system. By doing so, the Cerenkov radiation created in the ionizing radiation diffuser block can be filtered out. To prevent Cerenkov radiation originating from a diffuser block positioned between the radiation source, which is outside the beam inspection device, and the discriminating device the interface between this diffuser block and the scintillator can be painted black such that Cerenkov radiation is blocked on its way to the imaging device.

Advantageously, the beam inspection device can further comprise an anti-re-excitation filter between the scintillator and the ionizing radiation diffuser block, arranged between the scintillator and the imaging system and which is configured to absorb partially Cerenkov radiation generated in the diffuser block. By doing so, it is prevented that Cerenkov light, produced in the diffuser block and being emitted in all directions can reach the scintillator which can have the effect of re-exciting the scintillator thereby creating secondary scintillation radiation which does not carry any dose information.

Preferably, the beam inspection device can further comprise a Cerenkov radiation filter arranged between the ionizing radiation diffuser block, arranged between the scintillator and the imaging system, and the imaging system. Such a filter, which preferably has a spectral transmission which fits the spectral emission of the scintillator reduces even further Cerenkov light received by the canera, thereby further improving the discrimination capability of the device.

Advantageously, the imaging system can be protected against ionizing radiation using a lead shielding. Ionizing radiation reaching the camera can lead to defects in the camera, in particular in case of two dimensional CCD cameras, so called “hot pixels” can be created, thereby degrading the CCD performance. This negative effect can be limited by providing a lead shielding.

Preferably a mirror could be used to deviate the scintillation light outside of the ionizing beam field to thereby further shield the camera from ionizing radiation.

Advantageously, the beam inspection device can further comprise a second scintillator perpendicular to the first scintillator, at least one further ionizing radiation diffuser block and a second imaging system which is arranged such that, at the same time, a depth dose and a beam profile at a given depth are detectable which makes the beam detection even faster.

The disclosure also relates to a radiotherapy device comprising a device for discriminating Cerenkov and scintillation radiation as described above, or a beam inspection device as described above.

The disclosure also relates to a method for discriminating Cerenkov and scintillation radiation. With this method, the same advantageous effects as with the discriminating device or the beam inspection device can be achieved.

The second object of the disclosure is achieved with the imaging apparatus of claim 19 and the method according to claim 29. The disclosure takes advantage of the fact that typically the parasitic contributions vary only slowly in the spatial domain, so that by shifting the information contained in the signal of interest to higher frequencies by using a spatial modulation mask, the two contributions are sufficiently separated in the spectral domain so that it becomes possible to reduce the parasitic contribution to a signal of interest at least partially in a very effect way. Of course the object itself is not part of the imaging apparatus.

In this context a signal of interest can be any signal one wants to image. In this sense a signal emitted from the imaged object means any light leaving the object, e.g. light transmitted through the object, light leaving the object which was created inside the object, like in a scintillator, or light diffracted by the object, with the enumeration not being exhaustive. As a consequence best results are achieved when the original signal of the image is spatially modulated without an interaction with the parasitic light. The modulation is made in the real space and not in the Fourier space.

Preferably, the modulation mask can be a spatial modulation mask comprising a periodically arranged transmittance pattern. A spatial modulation mask with a periodically arranged transmittance pattern can modulate a signal of interest with a characteristic high frequency component, such that in the spectral domain the signal of interest is also carried by higher frequency. This fact is then used to distinguish, in the spectral domain, the unmodulated, typically low frequency parasitic contributions from a signal component containing the signal of interest.

Advantageously the modulation mask can have a single spatial periodicity. A modulation mask with a single spatial periodicity produces a modulation signal with only one fundamental frequency peak in the spectral domain, which allows for an improved quality of image reconstruction compared to a modulation signal with a plurality of frequency peaks in the spectral domain as here the data analysis is less complex.

Preferably the imaging apparatus can further comprise an image recording means, wherein the transmittance pattern of the modulating mask is configured and arranged in a tilted, in particular diagonal, way with respect to the coordinate system of the image recording means. A diagonal pattern has the advantage that with a single fundamental frequency peak it is possible to modulate the signal of interest such that parasitic contributions can be removed for both directions in a two dimensional image.

According to an advantageous embodiment the transmittance pattern of the modulating mask can be a grey level pattern, in particular a sinusoidal grey level pattern. By using a grey level pattern, a substantially sinusoidal pattern can be modeled such that secondary peaks in the frequency spectrum of the modulation signal can be reduced and/or are less intense, thereby the quality of demodulation can be improved by facilitating the numerical analysis of the recorded image.

According to an advantageous variant the transmittance pattern can correspond to a substantially binary pattern of alternating stripes of high and low transmission. By using a substantially binary pattern, the fundamental frequency of the modulation signal can be maximized, thereby improving the distinction of the modulated signal of interest from the parasitic signal.

Advantageously one period of the transmittance pattern can cover at least four sensor elements or pixels of the image recording means. When the pattern period covers four sensor elements, the fundamental frequency of the modulation signal is maximized with respect to the resolution of the image recording means. Thus the parasitic contributions with frequencies lower than this maximum modulation frequency can be reduced or even removed from a recorded image.

Advantageously the imaging apparatus can further comprise an imaging means, wherein the modulation mask is placed in or close to the object plane of the imaging means such that in use the modulation mask is placed between the position of an object to be imaged and the imaging means. Thus the effect of the modulating mask takes place in real space and not in the Fourier space.

Preferably the modulation mask can be directly placed adjacent the object. By doing so the sources of parasitic contributions downstream the object can effectively be taken into account and removed after demodulation. The main condition is to spatially modulate the light of interest whereas the parasitic light should stay unmodulated.

According to an advantageous embodiment the modulation mask can be placed between an X-ray source and the object to be imaged. When signal of interest is composed of X-rays and the mask is disposed between the X-ray source and the object, a modulation of the signal of interest can be achieved such that parasitic contributions due to X-ray diffusion in the object to be imaged can reduced. This is possible because the image is made without any optics in this case and the image of interest is a contrast image produced by the X-rays emitted directly by the source. X-ray diffusion on the object produce additional quasi isotropic X-ray emission which is superposed with the signal of interest. It is no more modulated because it is a superposition of all the diffused X-rays in the object volume. Thus an improved X-ray absorption image can be obtained.

Concerning the method, the removing step of the disclosed method can advantageously comprise:

Fourier transforming the modulated signal and the parasitic contribution, thereby obtaining a spectral domain signal, and removing frequency components of the spectral domain signal that are situated below the main (fundamental) modulation frequency of the modulation mask, to thereby create a first filtered signal. Using the Fourier transformation it becomes possible to identify the low frequency components in the measured signal which are attributed to parasitic contributions.

Preferably the method can further comprise the steps of transforming the first filtered signal into the spatial domain by inverse Fourier transformation and multiplying the outcome with the modulating function of the modulating mask, thereby obtaining a signal in the spatial domain, Fourier transforming the signal in the spatial domain, thereby creating spectral domain signal and low pass filtering the spectral domain signal thereby removing spectral information not associated with the signal of interest to thereby create a second filtered signal, and demodulating the second filtered signal into the spatial domain by inverse Fourier transformation, to thereby create the image signal. This method allows the shift back of the signal of interest towards its original frequency spectrum and thus its original spatial distribution in a simple manner.

According to a variant the demodulation of the first filtered signal can be based on a Hilbert transformation to obtain the signal of interest. By using the Hilbert transform, the image of interest can be reconstructed without the need of an a priori knowledge of the modulation mask thereby facilitating the numerical analysis of the captured image.

Advantageously the main modulation frequency of the spatial modulation mask can be higher than the spectral band of the signal of interest. When the spectral band of the signal of interest is lower than the frequency of the mask, image information can be restored using the Hilbert transformation with less degradation.

### BRIEF DESCRIPTION OF THE DRAWINGS

In the following advantageous embodiments of the disclosure will be described by referring to the figures:

FIG. 1 an embodiment of a device for discriminating Cerenkov and scintillation radiation according to the disclosure,

FIGS. 2a and 2b illustrates an embodiment of a beam inspection device comprising a device for discriminating Cerenkov and scintillation radiation according to the disclosure in two different inspection modes,

FIG. 3 illustrates the wavelength dependency of Cerenkov radiation and the transmission and emission properties of a scintillator and an anti-re-excitation filter respectively,

FIG. 4 illustrates a depth dose profile achieved with the beam inspection device illustrated in FIG. 2a,

FIG. 5 illustrates a beam profile at a given depth achieved with the beam inspection device illustrated in FIG. 2b,

FIG. 6 illustrates a second embodiment of the beam inspection device according to the disclosure,

FIG. 7 illustrates a third disclosed embodiment, namely an imaging apparatus comprising means for reducing parasitic contributions from an image,

FIG. 8 illustrates a practical application of the imaging apparatus according to the third embodiment,

FIG. 9 illustrates the modulation mask effect in the frequency space on a signal of interest, the upper images illustrate the situation in the real space and the lower images the frequency space,

FIG. 10 illustrates a modulating mask in the form of a black and transparent checkerboard in the real space (left) and frequency space (right),

FIG. 11: illustrates a modulation mask according to the disclosure with a single spatial periodicity which is diagonal and with a binary pattern of alternating black and transparent stripes in the real space (left) and frequency space (right),

FIG. 12 illustrates a modulation mask according to the disclosure with a single spatial periodicity wherein the transmittance pattern is a grey level diagonal modulation mask in the real space (left) and frequency space (right),

FIG. 13 illustrates a signal of interest and a parasitic contribution in an experimental example using the imaging apparatus according to the disclosure,

FIG. 14 illustrates the measured image in the experimental example modulated by the three types of masks in the real space (left) and frequency space (right),

FIG. 15 illustrates the results of the signal demodulation with the three types of masks, and

FIG. 16 illustrates a fourth embodiment of the disclosure, namely the imaging apparatus according to the disclosure applied to X-ray imaging.

### DETAILED DESCRIPTION OF THE PREFERRED EMBODIMENT

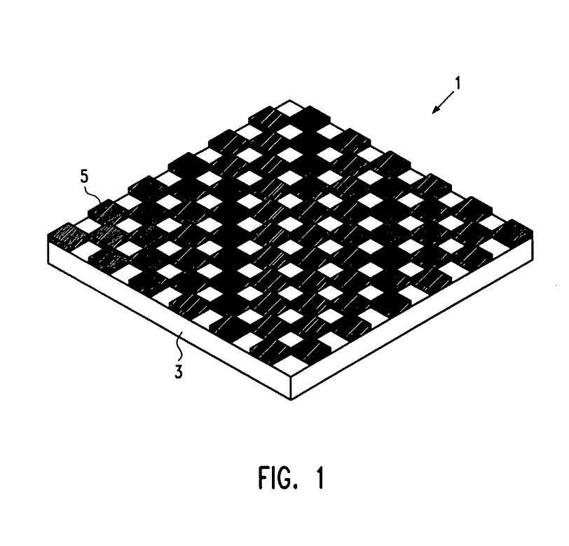

FIG. 1 illustrates a first embodiment of a device for discriminating Cerenkov and scintillation radiation according to the disclosure. It can serve for example in beam inspection devices used to adjust and control ionizing radiation beams to improve the quality of measured signals by delimiting the impact of parasitic radiation, in this case, Cerenkov radiation. Such beam inspection devices can find their application in medical equipment of radiotherapy to treat cancer.

The device for discriminating Cerenkov and scintillation radiation 1, illustrated in FIG. 1, comprises a first layer 3, which can be a plastic sheet, in particular a polystyrene or Plexiglas sheet, and a second layer 5 with a regular periodically arranged pattern. In this embodiment, the arranged pattern corresponds to a checkerboard and is made of squares, in particular black ink squares. However, the checkerboard pattern only serves as one possible example of a periodically arranged pattern, in fact any periodically arranged pattern is suitable for the disclosure. In addition, the ink squares could also have different forms, such as a rectangular form, thus the periodicity of the pattern does not need to be the same in the two directions of the plane of the layer.

The second layer 5 and the first layer 3 have different transmission/absorption properties so that they form first and second filters. The transmission/absorption properties of the black ink squares in the second layer 5, serving as second filters, are chosen such that they are opaque for one wavelength region and transparent for a second wavelength region, whereas the first layer 3 serving as first filters in the regions without the black squares is transparent in both wavelength regions.

In this embodiment the first wavelength region corresponds to the emission spectrum of a scintillator, typically in the visible wavelength range, and the second wavelength region to the spectrum of an ionizing radiation beam, typically at higher energy than the first wavelength region. The transmission properties of the embodiment represent one possibility. In fact it is sufficient that the first and second filters realized by the first and second layer 3 and 5, represent different absorption properties with respect to the first and second wavelength region. Thus the absorption behaviors of the first filter in the first and second wavelength region is different than the absorption behaviors of the second filter in these regions, at least for one wavelength region.

A device 1 can further comprise a signal analyzing means which is configured to extract the scintillation radiation contribution out of a signal comprising scintillation and parasitic radiation such as Cerenkov radiation based on a Fourier transform algorithm. Fourier analysis becomes possible as a consequence of the periodically arranged first and second filters in the device 1. However, also other equivalent types of algorithms could be used to extract the scintillation radiation contribution.

The way the device 1 works to extract the scintillation radiation contribution will be explained in more detail in conjunction with the description of the first disclosed embodiment of a beam inspection device according to the disclosure.

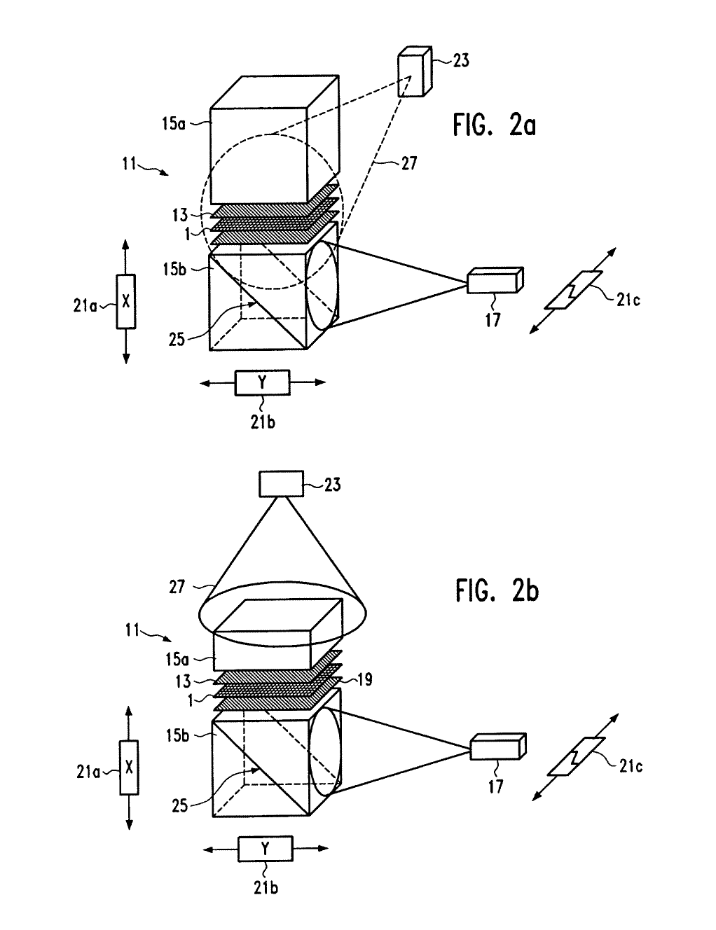

FIGS. 2a and 2b illustrate a beam inspection device comprising the device for discriminating Cerenkov and scintillation radiation as described above. A beam inspection device, however, is only one possible example of the use of the disclosed device for discriminating Cerenkov and scintillation radiation, the advantageous properties of which could also be exploited in other devices in which radiation of one wavelength needs to be separated from a parasitic contribution.

The beam inspection device 11 is used to analyze the properties of ionizing beams used in radiotherapy. In radiotherapy, ionizing beams are used to destroy tumor cells of a patient. The beam shall, however, only destroy tumor cells and the exposure of healthy tissue needs to be minimized. To be able to precisely carry out the irradiation of tumor cells of a patient, the radiation dose distribution inside a body is therefore beforehand modeled using a beam inspection device.

The beam inspection device 11 illustrated in FIG. 2a, comprises an inspection head modeled the patient and which comprises a scintillator 13, which is a material which reacts to ionizing radiation by emitting light, and a diffuser 15a, 15b diffusing ionizing radiation. In this embodiment, the diffuser is composed of two blocks, however, it is also possible to have inspection heads with only one block or more than two blocks. Furthermore, the beam inspection device 11 comprises an imaging system 17 configured and arranged to form an image of the inspection head, in particular of the scintillator 13 and diffuser block 15b arranged between the scintillator 13 and the imaging system 17. Furthermore the beam inspection device 11 comprises the device for discriminating Cerenkov and scintillation radiation 1, as illustrated in FIG. 1 and described above, which is positioned between the scintillator 13 and the diffuser block 15b.

Optionally, according to further variants, the inspection device 11 may comprise an anti-re-excitation filter 19 positioned between the device for discriminating Cerenkov and scintillation radiation 1 and the diffuser block 15b and/or further filters.

In addition, the beam inspection device 11 can be equipped with moving means 21a, 21b and 21c which allow to shift the beam inspection device 11 with respect to an ionizing radiation beam source 23, which may or may not be part of the beam inspection device 11. In this embodiment, the movements are translational, however, the moving means could be designed to provide in addition or alternatively rotational movements. The moving means allow to explore different geometries of the inspection head and thus, enable to measure the radiation dose to be deposited in a certain volume, therefore enabling 3D measurements.

Finally, in this embodiment, a mirror 25 is positioned in the diffuser block 15b to relay light coming from the scintillator 13 towards the imaging system 17.

The scintillator 13 is in the form of a solid and homogeneous plate with two opposite principal faces. The plate shaped scintillator 13 is advantageous with respect to an array of scintillator fibers each coupled to an optic fiber, as it is considerably cheaper in fabrication and furthermore, the resolution of the beam inspection device is not bound to the construction of the scintillator but essentially depends on the image of the scintillator plate provided by the imaging system 17 and on the cell size for discriminating Cerenkov and scintillator radiations. The scintillator plate preferably has a thickness of more than 1 mm to about 5 mm with the principal faces having a surface of about 100-900 cm², Here, a rectangular scintillator 13 is illustrated. However, other forms, such as round or elliptical forms are also possible to better simulate the body of a patient. The material of the scintillator 13 has the property that it scintillates when it is exposed to ionizing radiation which is the consequence of secondary electrons produced in the scintillator material. Due to this property, the scintillator 13 emits scintillation radiation, the intensity of which is proportional to the radiation dose received in each point of the plane of the scintillator, thus, a cross section of the ionizing beam along this plane. The scintillator 13 is a solid solution of luminophors (luminescent additives) in a transparent polymer such as polystyrene or PMMA.

The diffuser block 15a and 15b play the role of simulating the diffusion of the ionizing radiation by the environment of the target and thus permit to simulate a patient's body. The thickness of the diffuser blocks is chosen as a function of the importance of the diffusion phenomenon which needs to be taken into account. Typically for scintillators 13 as described above, diffuser blocks with 150 mm-400 mm thickness are used. In this embodiment they are formed of cubes, however, their form may vary. Typically they cover all or only a part of the scintillator surfaces. To use the beam inspection device for radiotherapy purposes, the scintillator 13 and the diffuser 15a, 15b are preferably made of a material having absorption coefficients close to that of living tissue. The diffuser blocks 15a and 15b can be made out of plastic materials such as polystyrene, polyvinyltoluene or PMMA.

The imaging system 17 comprises a photon counting camera, in particular a photon counting camera or a CCD, and an objective which permits the formation of an image of the scintillator 13 and the diffuser blocks 15a 15b. The camera output signal is used to calculate the dose as a function of the light intensity in the different parts of the image, thus providing a 2D dose profile. To facilitate the imaging of the scintillator 13, the diffuser block 15b may be made of a transparent material. In this case, the scintillation radiation easily propagates through the block 15b to the camera of the imagining device 17.

The mirror 25 is provided to relay the scintillation radiation towards the camera, which has the advantage that the imaging device 17 can be shielded from the ionizing radiation beam. In this embodiment, the relay mirror 25 is inserted inside the diffuser block 15b, but according to a variant, it could also be placed separately, outside the diffuser block 15b. Typically, the mirror is a reflective metallic coating which is deposited on a diagonal section of the cube 15b.

To even further protect the camera from harmful ionizing radiation which could lead to hot pixels in the camera, the imaging system 17 may be protected by a lead shielding, the design of which is the result of calculations and simulations.

The extraction of the scintillation radiation using the device for discriminating Cerenkov and scintillation radiation 1 according to the first embodiment of the disclosure will now be described in detail.

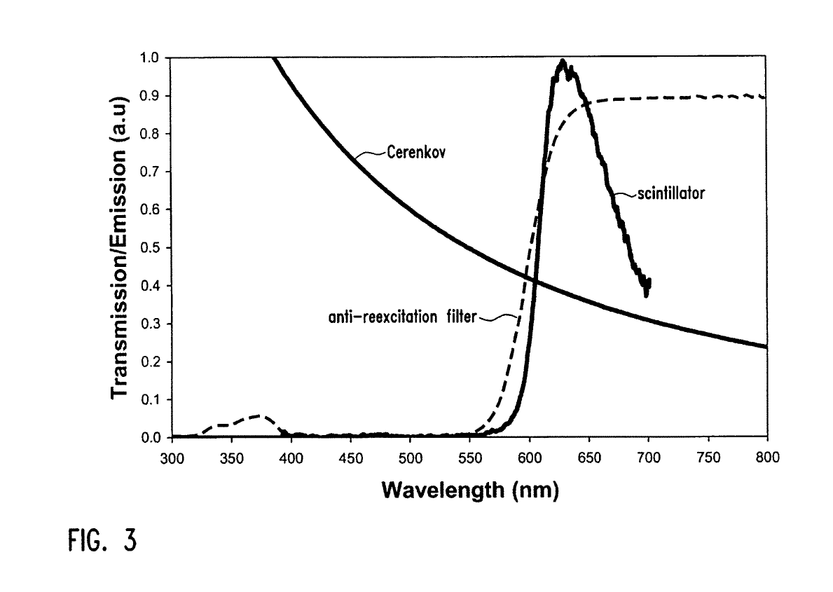

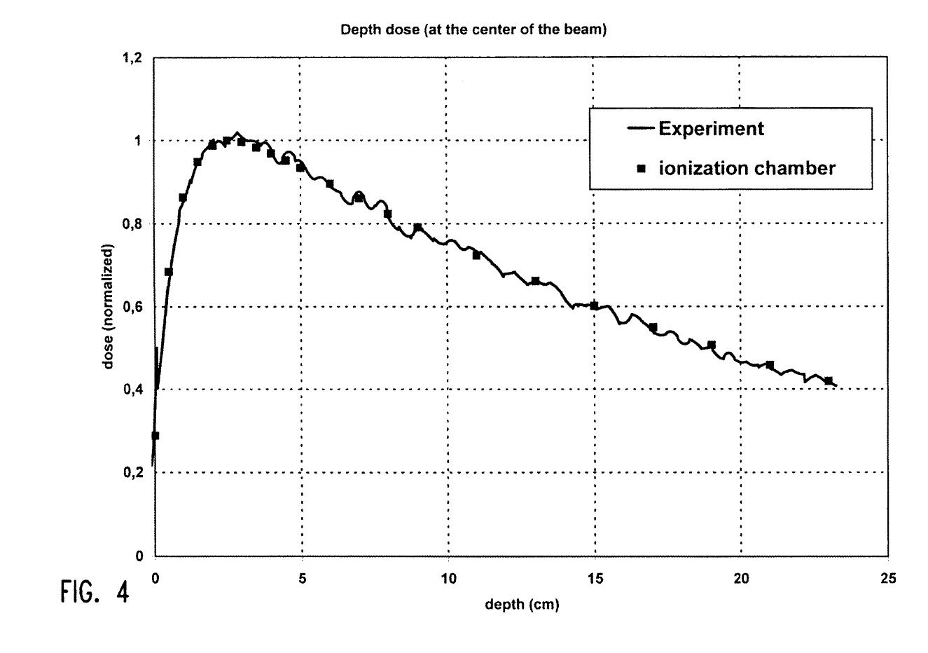

The diffuser block 15b, when subjected to the ionizing radiation beam, illustrated by cone 27 in FIG. 2a, can lead to the creation of parasitic radiation, the so called Cerenkov radiation. The Cerenkov radiation is associated with charged atomic particles moving at velocities higher than the speed of light in the local medium. The effect occurs in the scintillator 13 but also and to a larger extent in the diffuser blocks 15a and 15b due to their greater thickness. FIG. 3 illustrates the emission of Cerenkov radiation as a function of wavelength and illustrates the inverse wavelength to the square dependency of the radiation. The Cerenkov radiation is thus emitted at all frequencies in the visible range, when it occurs in an optically transparent medium, which is the case for the described diffuser block, and, furthermore, emits under all angles.

The Cerenkov radiation created adds to the scintillation radiation and therefore falsifies the calculation of the actual radiation dose deposited by the ionizing beam 27 in the scintillator 13, as the imaging device 17 measures the sum of the two contributions. The use of the inventive Cerenkov and scintillation and radiation discriminating device 1 allows to remove the Cerenkov light contribution at least partially from the signal measured by the imaging device 17 and to thereby calculate the actual radiation dose received by the scintillator 13. By providing the checkerboard between the scintillator 13 and the diffuser block 15b situated towards the camera, the image captured by the imaging system 17 is the image of the scintillator 13 seen through the device 1. Recalling the properties of the discrimination device 1, namely that the second filters, represented by the second layer 5, are transparent to the ionizing radiation only and that the first filters, represented by the first layer 3, are transparent to both the scintillator radiation and the ionizing radiation, each point of the image which corresponds to the position of a black square of layer 5 will, thus, only have one contribution, namely the Cerenkov radiation created by the ionizing radiation beam, whereas positions corresponding to the first filter positions will represent two contributions, namely the scintillation radiation and the parasitic Cerenkov radiation.

Due to the periodic arrangement of the first and second filters, the image captured by the imaging system 17 carries the information concerning the spurious Cerenkov radiation. Therefore, when processing the signal received from the camera using, for example, Fourier transformation algorithms, the amplitude of the signal modulation between black and “white” squares can be deduced for each point of the image. The amplitude of this modulation is the response to the scintillation light intensity cleared from the Cerenkov contribution. Thus, the Cerenkov and scintillation radiation discrimination device allows the improvement of the radiation dose determination in a two-dimensional manner. To do so the beam inspection device 11 or the device 1 comprises a calculation unit (not illustrated).

The beam inspection device 11 can be further improved by optional additional features and/or elements according to further disclosed embodiments.

First of all, the scintillator material can be chosen such that the scintillation radiation is in a region of relatively high wavelength compared to the Cerenkov radiation to limit the impact of any Cerenkov radiation on the scintillator radiation. FIG. 3 illustrating the Cerenkov radiation dependency, furthermore illustrates a typical scintillator emission which depends on the scintillator material.

Cerenkov light produced in the diffuser blocks is, as already mentioned, emitted in all directions and, thus, can partly reach the scintillator 13, either from block 15a or from block 15b, and can have the effect of re-exciting the scintillator 13, thereby leading to a secondary scintillation radiation emission, which does not create any further information about the radiation dose received by the scintillator 13 from the ionizing radiation beam. This secondary scintillation emission thus needs to be filtered out or needs to be prevented. Thus, according to a further variant, the scintillator plate surface facing the diffuser block 15a can be painted in black so that Cerenkov light produced in this diffuser block 15a is blocked and cannot reach the scintillator 13, whereas the ionizing radiation can still reach the scintillator 13.

Of course, by providing device 1, the Cerenkov contribution that is created in the diffuser block 15b, thus the one situated downwards behind the scintillator 13 and the device 1, can be determined and taken into account. By preventing Cerenkov radiation created in the diffuser block 15a entering into the scintillator 13, this source of Cerenkov contribution to the image captured by the imaging system 17 can also be excluded at least to a large extent. A black paint is generally applied to the entire surface of the diffuser block 15a to avoid this effect. Alternatively another visible light blocking means could be placed in front of the scintillator to prevent the Cerenkov radiation from entering the scintillator 13. Finally a third source of Cerenkov radiation is the scintillator 13 itself. Like already mentioned due to is small thickness of 1 to 5 mm compared to the diffuser block having a thickness of 150 nm to 400 nm, its contribution can essentially be neglected. Since the scintillator 13 and the block 15a and 15b are made of the same material for density questions (and preferably in polystyrene), the cross section for the creation of Cerenkov radiation is quasi the same in the scintillator 13 and in the diffuser block 15b by unit of volume. So the contribution of the Cerenkov radiation induced in the scintillator 13 compared to the total Cerenkov radiation is therefore at most of the order of about 2.5% and thus does not play an important role.

According to a further variant, the additional anti-re-excitation filter 19, for example a gelatine filter, can be inserted between the scintillator 13 and the diffuser block 15b situated towards the imaging system 17. The absorption properties of this filter 19 are chosen such that Cerenkov light coming backwards from the diffuser block 15b is absorbed so that a re-excitation of the scintillator 13 can be prevented. The absorption properties of the filter 19 shall be chosen such that a maximum of Cerenkov radiation will be absorbed, in particular, high energy Cerenkov radiation, while only a minimum of scintillation radiation is absorbed. This is further illustrated in FIG. 3 which, in addition to the Cerenkov radiation properties and the scintillator radiation properties, also illustrates the transmission properties of a suitable anti-re-excitation filter 19, blocking off high energy Cerenkov radiation.

Yet another variant consists in providing an additional filter arranged between the diffuser block 15b and the imaging system 17 and which in turn also shall fit the spectral emission of the scintillator to reduce the Cerenkov parasitic contribution to the signal. This additional filter is not illustrated in the figures.

The beam inspection device or the device for discriminating Cerenkov and scintillation radiation furthermore comprises the calculation unit designed to carry out the Fourier transformation algorithm on the signal and which, furthermore, may be designed to display the images. This calculation unit can, furthermore, be configured to drive the moving means 21a, 21b and 21c to allow the computation of the radiation dose of the ionizing beam in three dimensions.

Finally, all parts of the beam inspection device, except the ones which shall transmit scintillation radiation can be painted in matte black in order to reduce parasitic reflections. The optical index of the black paint can also be selected to match the index of polystyrene in order to minimize the parasitic reflections.

The above described variants to the disclosed embodiment of the beam inspection device can, of course, be combined in any combination.

The beam inspection device 11 undergoes the following calibration procedure before dose information can be obtained. First, the optical response of the device 11 needs to be determined. The optical response depends primarily on the quality of the imaging system 17 and, in particular, its optics, and secondarily, on the response of the different filters 19, the scintillator 13, the discriminating device 1, the diffuser blocks 15a, 15b, and the deformation possibly introduced by the mirror 25. Thereto, the inspection head is illuminated with a uniform beam field. In case linear accelerators are employed, which are typically used in radiotherapy, the ionizing beam source to be examined can be directly used to calibrate the beam inspection device 11, as an accelerator can produce large beam fields with sizes of 30×30 cm being uniform within a few percent. The calibration images are then used to subsequently correct acquisitions representing the dose distribution of the examined beam. It is sufficient to carry out this calibration step only once for a given beam inspection device.

To be capable of providing absolute dose measurements, the beam inspection device 11 has then to be calibrated to absolute values. This is done by using one or several calibration ionisation chambers known in the art, which are small sized chambers which can be placed in the scintillator 13 or in its direct neighbourhood. The calibration occurs by adjustment of the radiation dose value obtained from the scintillator image for one or several areas corresponding to ionisation chambers places to the dose values provided by the ionization chambers. Once calibrated, the device 11 will be able to provide absolute values of the radiation dose deposited by an ionizing radiation beam. Again, this calibration needs to be carried out only once for a given beam inspection device.

In the arrangement of FIG. 2a, the ionizing radiation beam 27 is positioned perpendicular to the normal of the plane of the scintillator 13. In this configuration, the image of the scintillator plate captured by the camera corresponds to a transverse section of the inspection head which simulates a patient lying horizontally and being irradiated vertically. The cross-section of the scintillator plate image along the Z-axis represents the depth dose distribution at a given distance from the ionizing beam and the cross-section along the Y-axis represents a cross-section of the beam profile at a given depth (Z-position). Using the moving means along the Z-axis allows to adjust the source skin distance, which is the distance measured along the central ray from the centre of the front surface of the radiation source 23 to the surface of the irradiated inspection head, simulating the patient.

FIG. 4 illustrates such a depth dose profile at the centre of the beam field which can be achieved by the beam inspection device 11 according to the disclosure (solid lines). This depth dose profile is compared with a result of a depth dose measurement performed with ionising chambers under the same conditions. As the ionization chambers do not suffer from the parasitic Cerenkov contribution, one can realize that measurements obtained with the inventive beam inspection device correspond (within +/−2%) to the ones obtained with the ionisation chambers.

In FIG. 2b, representing a beam inspection device 11 as already described with respect to FIG. 2a, the ionizing beam emitted from the source 23 is parallel to the normal of the scintillator 13. In this configuration, the scintillator image provides the beam profile at a given depth. This configuration is equivalent to a longitudinal section of the inspection head simulating the irradiated patient lying horizontally and being irradiated vertically. The depth depends on the source skin distance or the source detector distance, which is the distance measured along the central ray from the center front surface 23 to the active surface of the detector of the imaging system 17. This distance can be adjusted with the help of the moving means along the X-axis, wherein furthermore, the thickness of the diffuser block situated between the detector and the source also needs to be varied in order to simulate the required depth while remaining tissue equivalent.

In this configuration the advantageous role of mirror 25 becomes evident, as without the mirror 25 the imaging system 17 would be in the propagation direction of beam 27.

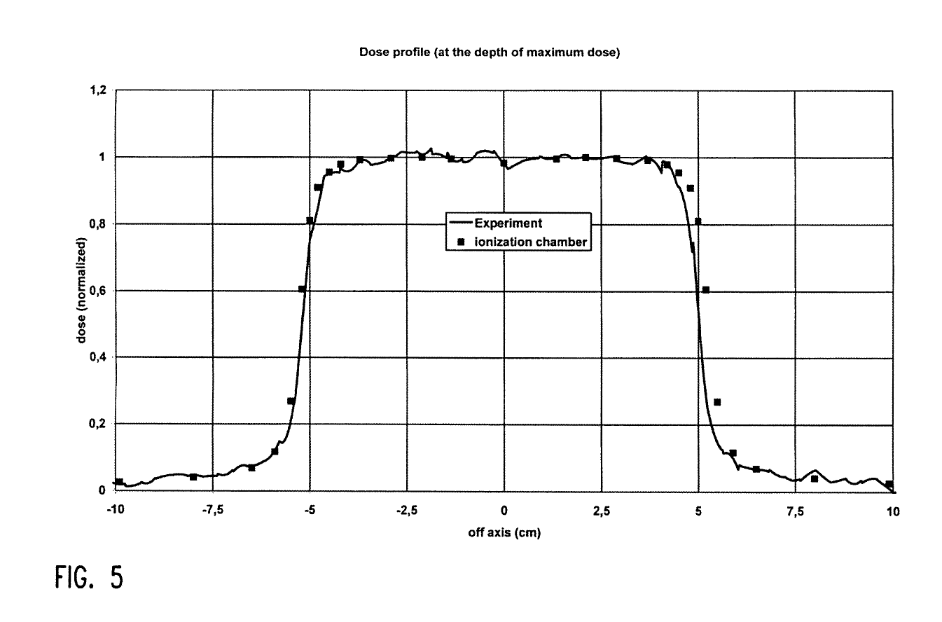

FIG. 5 shows a corresponding beam profile at the depth of maximum dose again compared to the measurements performed with an ionisation chamber under the same conditions. Again, both measurements match each other. In both cases, by moving the device along the X-axis, a stack of images can be acquired and subsequently be used to construct a 3D topography of the dose deposited by the ionizing beam in the inspection head simulating a patient.

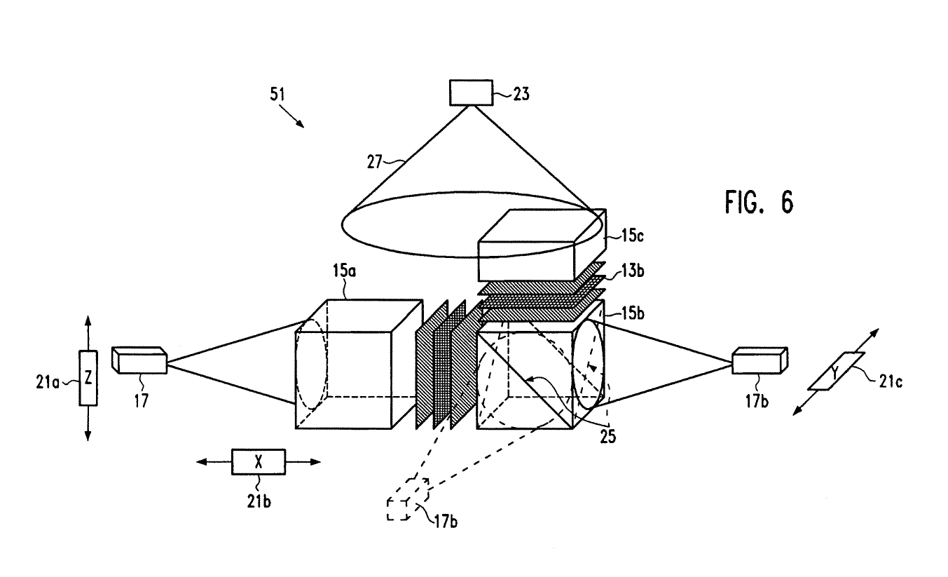

FIG. 6 illustrates a second inventive embodiment concerning the beam inspection device which is a hybrid of the two setups illustrated in FIGS. 2a and 2b. This configuration allows to acquire at the same time an image representing a transverse section (Y, Z axis) and another representing a longitudinal section (X, Y axis) of an irradiated inspection head representing a patient lying horizontally and being irradiated vertically. Thus, at the same time, the depth dose and the profile of the ionizing radiation beam can be analyzed. Elements having the same reference numerals as in FIG. 2a will not be explained in detail again, but their description is incorporated herewith by reference.

The beam inspection device according to the second embodiment comprises a first scintillator 13 positioned vertically between two diffuser blocks 15a and 15b. The scintillator 13 is irradiated vertically by the ionizing radiation beam 27 and its image is captured by a first imaging device 17 positioned on the same axis as the normal of the plane of the first scintillator 13. With this part of the device, the depth dose distribution of the ionizing beam can be determined (see FIG. 4).

A second scintillator 13b having the same properties as the first scintillator, except potentially for its size, is positioned horizontally on top of diffuser block 15b situated on the opposite side from the first imaging device 17 and a third diffuser block 15c is placed on top of the second scintillator 13b. The thickness of the third diffuser block 15c is adjusted to simulate the required depth. The image of the second scintillator 13b, is then relayed by a mirror 25 to a second imaging device 17b, which can be placed on the same axis as the first imaging system, or, according to a variant, being placed perpendicular to it, see dotted lines. The position of the mirror 25 inserted in this embodiment in the diffuser block 15c depends on the positioning of the second imaging device 17b. The image obtained with the second imaging system 17b then renders the profile of the examined ionizing radiation beam (corresponding to FIG. 5).

All the variants disclosed with respect to the first embodiment are, of course, also applicable to this second embodiment and can be combined in any way.

The device 1 for discriminating Cerenkov and scintillation radiation and/or the beam inspection device 11 according to the above-described embodiment can also be integrally part of a radiotherapy device. However, the application of the Cerenkov and scintillation discriminating device 11 is not exclusively linked to the application to radiotherapy, but the device itself can also be used in other applications.

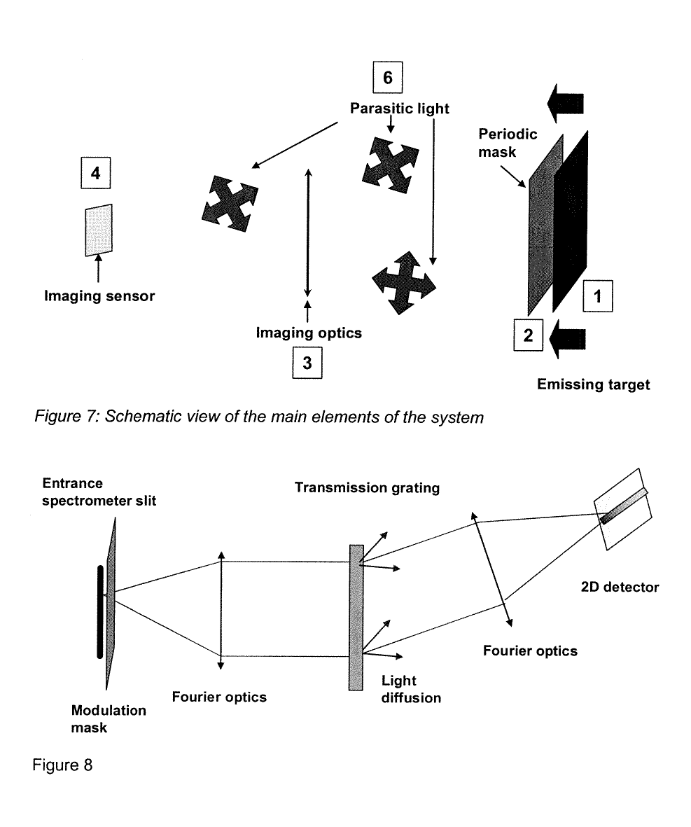

FIG. 7 illustrates a third embodiment of the disclosure. It represents an imaging apparatus 51 comprising means for reducing parasitic contributions from an image of an object 53. The imaging apparatus comprises a spatial modulation mask 55, imaging means 57, in particular a lens system, image recording means 59 and image analyzing means 61. The object 53 is positioned in the focal plane of the imaging means 57 and, according to the disclosure the modulation mask is positioned directly adjacent the object 53 such that it is also positioned in or close to the focal plane of the imaging means 57, thus in the real space. The object is thus imaged onto the image recording means 59, wherein the light leaving the object 53 is modulated by the modulating mask 55.

The imaging apparatus 51 according to the present disclosure can be used according to the method for reducing parasitic contributions according to the disclosure, to extract an image of interest, in this embodiment the image of the object 53, from a signal comprising besides the signal of interest also parasitic contributions 63, resulting from the superposition of several light signals originating from different sources than the source of the image of interest.

The problem is to image an object 53 avoiding any parasitic light 63 which can come in the optical path of the imaging device 57, 59. The basic disclosed idea is to use the modulating mask 55 which comprises a periodical arrangement of transparent and black patterns, e.g. square, stripe or circle pattern, or with a sinusoidal transmittance pattern, placed directly on the emissive surface of the object 53. In this context emissive means that the object 53 itself may emit light, but could also mean that light is reflected by the object 53 or that light is transmitted through the object 53, where the light comes from a light source positioned upstream.

The modulating mask 55 will modulate the light of interest in the vicinity of the object 53 itself. Thus the spatial spectrum of this signal is shifted towards higher frequencies. In contrast thereto the parasitic signals 63 downstream the modulating mask 55 are not modulated and thus remain in the low frequency region of the spatial spectrum under the assumption that parasitic light usually varies only slowly in the spatial domain, thus represents mainly contributions in the lower frequency domain.

In this way a frequency analysis of the image recorded by the image recording means 59 permits to separate—in the spectral domain—the signal of interest from the parasitic signals by appropriately filtering the recorded spatial spectrum. Ways to do so will be described further down.

The method can particularly be applied each time the surface of the object of interest is naturally flat and accessible to position a periodic mask.

The imaging apparatus according to the third embodiment of course also finds its application in the above described dosimeters, with the scintillator 13 representing the object 53 to be imaged and device 1 corresponding to the modulation mask 55. The modulation mask 55 is thus closely located to the plastic scintillator sheet 13 which produces the light corresponding to the dose distribution in this section as the signal of interest. The parasitic contribution 63 is produced by the Cerenkov radiation produced everywhere inside the polystyrene cube 15b provided downstream the modulating mask 55.

Another practical application of the imaging apparatus according to the third embodiment is reported in FIG. 8. It concerns the improvement of imaging spectrographs 71. In this type of device the incoming light passing through an entrance slit 73 and a grating 75 positioned between two Fourier optics 77, 79 is imaged on a 2D detector 81 as image recording means. It furthermore comprises an image analyzing means 83. The spectrum of the light can then be obtained in one direction and the position along the entrance slit length in the other direction. An important drawback of such a imaging spectrograph 71 is the optical diffusion of the grating 75 that produces parasitic light which is superposed to the incident light and blur the signal detected by the 2D detector 81.

By introducing a modulation mask 55 along the entrance slit to modulate the input light, representing the signal of interest. This modulation is then again used to separate the input signal from the diffused parasitic contribution using the image analysing means 61 of the imaging apparatus of the third embodiment, which thus becomes part of the imaging spectrograph 71. The parasitic contribution itself is not modulated, because the parasitic contribution on one pixel of the detector 81 is the result of the superposition of the diffusion at different points of the grating 75. This is due to the fact that the light diffusion is essentially a quasi isotropic phenomenon.

The image recorded by the image recording means 59, 81 is the superposition of the signal of interest modulated by the modulating mask 55 and the parasitic contribution 63 occurring downstream the modulating mask 55 and which is not modulated. We present hereafter the mathematical treatment performed in 2D in the spectral domain by Fourier transforming the image resulting from the superposition of the signal of interest and the parasitic signals.

A 2D-data signal going through a modulating mask can be modeled as a spatial multiplication i.e. a spectral convolution. To describe the method a sinusoidal mask M and a sinusoidal signal S are considered. The extrapolation to any type of modulation mask and any signal can be achieved by considering the mask and/or the signal as a sum of different sinusoidal waves.

M(x,y)=1+sin(2π(wₘₓx+w_{my}·y)) (equation 1)

The result of the modulation of the signal S by the mask M is given by:

R(x,y)=S(x,y)·M(x,y)

Or

R(x,y)=1+sin(2π(wₛₓ+w_{sy}·y))+sin(2π(wₘₓ·x+w_{my}·y))+

sin(2π((wₘₓ−wₛₓ)·x+(w_{my}−w_{sy})·y))+sin(2π((wₘₓ+wₛₓ)·x+(w_{my}+w_{sy})·y)) (equation 2)

Equation 2 illustrates that the spatial spectrum of the modulated image is kept at low frequency and at the same time is duplicated near each peak corresponding to the frequency of the mask. In this context the contribution 1+sin(2π(wₛₓx+w_{sy}·y)) corresponds to low frequencies, and the contribution

+sin(2π(wₘₓ·+w_{my}·y))+sin(2π((wₘₓ−wₛₓ)·x+(w_{my}−w_{sy})·y))+sin(2π((wₘₓ+wₛₓ)·x+(w_{my}+w_{sy})·y)) corresponds to the modulation mask 55 plus the duplication of the signal of interest near each frequency peak of the modulation mask 55.

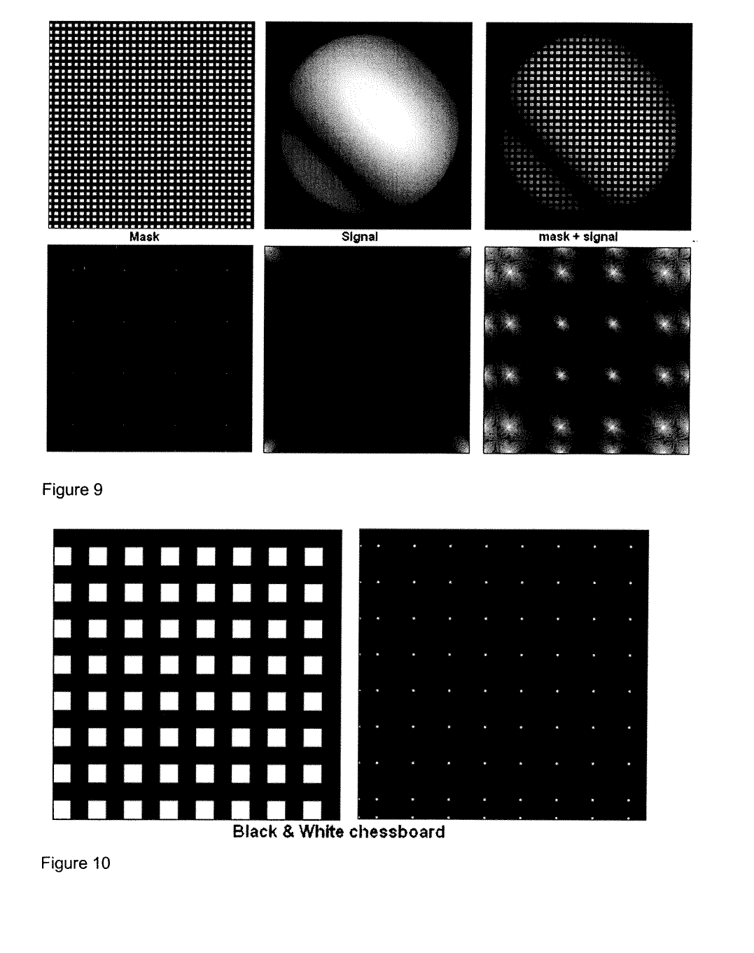

FIG. 9 illustrates this concept in case a modulating mask 55 like device 1 illustrated in FIG. 1, is used in the imaging apparatus 51. FIG. 9 is thus a simulation for a chessboard mask (upper left image) and an ovoid signal of interest (upper middle image). In the frequency space, the modulation mask is characterized by a series of well defined peaks (lower left image) and the ovoid signal by a distribution of frequencies near the origin (lower middle image). The use of the mask leading to the modulation of the signal of interest (upper right image) duplicates the signal of interest around all the frequency peaks of the modulating mask (lower right image).

Just as the signal of interest and the modulating signal (i.e. the mask), the parasitic contributions P can be modeled as a sinusoidal wave. Again, like above, a more complex parasitic signal can be modeled as a sum of different sinusoidal waves. Thus the resulting signal corresponding to the sum of the modulated signal of interest and the un-modulated parasitic signals is given as:

R(x,y)=1+sin(2π(wₛₓx+w_{sy}y))+sin(2π(wₚₓ+w_{py}y))+

sin(2π(wₘₓ·x+w_{my}·y))+sin(2π((wₘₓ−wₛₓ)·x+(w_{my}−w_{sy})·y))+

sin(2π((wₘₓ+wₛₓ)·x+(w_{my}+w_{sy})·y)) (equation 3)

As clearly put in evidence by equation 3, the spatial spectrum of the resultant image is divided in two parts: The low frequencies containing information about the image of interest and the parasitic signals, and the high frequencies containing only information about the image of interest. Thus according to the invention the signal of interest becomes shifted to higher frequencies, whereas the parasitic contribution keeps its original frequency behavior.

Since both the signal of interest and the modulation mask can be represented as a sum of sinusoids, the same development can easily be used for more complex signals with more complex information at low frequencies and for modulation masks with several secondary peaks.

The numerical treatment necessary to reconstruct the signal of interest, thus e.g. the image of the scintillator light of a dosimeter, is then separated in a three step process.

In a first step, the low frequencies situated below the frequency of the modulating mask 55 are removed (i.e. their intensity in the spectral domain is set to 0) to get rid of the parasitic signals. This also deletes part of the information on the image of interest (see equation 3) but this is irrelevant since this information is duplicated in the frequency domain and is situated near the peak corresponding to the mask spatial frequency. Thus R′ corresponds to the spatial spectrum of the resulting image filtered from its low frequencies information. It is given by:

$${R}^{′} ( x , y ) = sin ( 2 π ( \begin{matrix}{w}_{mx} . x + \\ {w}_{my} . y\end{matrix} ) ) + sin ( 2 π ( \begin{matrix}( {w}_{mx} - {w}_{sx} ) . x + \\ ( {w}_{my} - {w}_{sy} ) . y\end{matrix} ) ) + sin ( 2 π ( \begin{matrix}( {w}_{mx} + {w}_{sx} ) . x + \\ ( {w}_{my} + {w}_{sy} ) . y\end{matrix} ) ) \qquad ( equation 4 )$$

In a second step, the spatial spectrum of the image of interest, which is duplicated near the frequency corresponding to the period of the mask, is translated back to low frequencies.

One way to achieve this translation is to reverse to the spatial domain using an inverse Fourier transform, and multiply the filtered signal R′ by the modulating signal (i.e. the mask).

$$\begin{matrix}\begin{matrix}{R}^{″} ( x , y ) = {R}^{′} ( x , y ) \times sin ( 2 π ( {w}_{mx} . x + {w}_{my} . y ) ) \\ = {sin}^{2} ( 2 π ( {w}_{mx} . x + {w}_{my} . y ) ) + \\ [ \begin{matrix}sin ( 2 π ( ( {w}_{mx} - {w}_{sx} ) . x + ( {w}_{my} - {w}_{sy} ) . y ) ) + \\ sin ( 2 π ( ( {w}_{mx} + {w}_{sx} ) . x + ( {w}_{my} + {w}_{sy} ) . y ) )\end{matrix} ] \times \\ sin ( 2 π ( {w}_{mx} . x + {w}_{my} . y ) ) \\ = \frac{1}{2} + \frac{1}{2} cos ( 2 \times ( 2 π ( \begin{matrix}{w}_{mx} . x + \\ {w}_{my} . y\end{matrix} ) ) ) + cos ( 2 π ( \begin{matrix}{w}_{sx} x + \\ {w}_{sy} y\end{matrix} ) ) \\ - \frac{1}{2} [ \begin{matrix}cos ( 2 π ( ( 2 {w}_{mx} - {w}_{sx} ) . x + ( 2 {w}_{my} - {w}_{sy} ) . y ) ) + \\ cos ( 2 π ( ( 2 {w}_{mx} + {w}_{sx} ) . x + ( 2 {w}_{my} + {w}_{sy} ) . y ) )\end{matrix} ]\end{matrix} & ( equation 5 )\end{matrix}$$

As can be seen in equation 5, the spatial spectrum of the image resulting from the multiplication by the modulating signal is composed of a constant value, the modulating signal at twice the mask frequency, the signal of interest put back to low frequency and the signal of interest duplicated at high frequencies on each side of the frequency corresponding to twice the spatial frequency of the mask.

In a third step, this spatial spectrum is filtered with a low pass filter to remove all spectral information apart from the signal of interest and finally reversed to the spatial domain using an inverse Fourier Transform. This final image corresponds to the signal of interest filtered from the parasitic signals.

Therefore, in order to distinguish between the signal and the parasitic light in the frequency space it is necessary to use a modulation mask with frequency peaks well separated from the origin, close to which typical parasitic contributions will be positioned as the parasitic light usually only comprises low frequency contributions. To facilitate the numerical treatment of the recorded image data it is preferable that the modulating mask 55 has only a limited number of frequency peaks preferably only one single frequency peak.

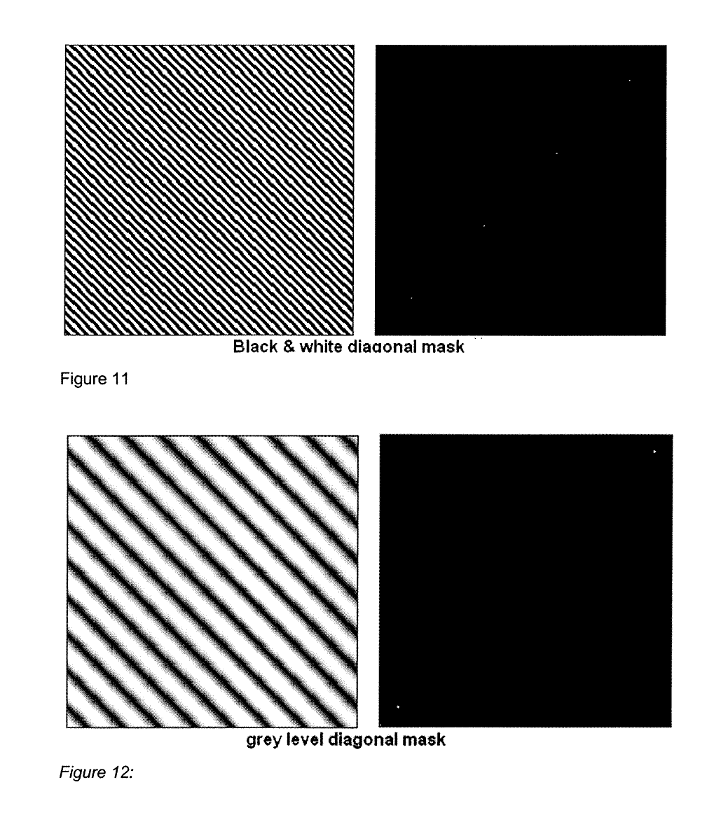

The modulation mask can be described by m(x, y) with a spectrum M (u, v) in the Fourier space. Its first period defines the upper limit for the frequency of parasitic contributions that can be removed or reduced from the measured signal. FIGS. 10 to 12 show three examples of modulation masks 55 according to the disclosure.

FIG. 10 illustrates a checkerboard type mask, just like device 1 illustrated in FIG. 1. Even though this type of modulation mask represents a high number of frequency peaks it still can be used in the imaging apparatus according to the third embodiment, the filters necessary to extract the signal of interest need to be adapted accordingly. More preferably modulating masks can be used which represent only a single periodicity in the spatial domain, like the diagonal binary mask illustrated in FIG. 11 and the diagonal grey level mask illustrated in FIG. 12. As compared to FIG. 10 these masks represent less secondary peaks in the spectral domain, which facilitates the numerical analysis.

In case of the mask illustrated in FIG. 11 consisting only of black and transparent patterns, the spatial spectrum nevertheless has frequency harmonics. The better solution lies therefore in the grey level diagonal mask of FIG. 12, where the modulation information is essentially entirely concentrated in one frequency peak.

The diagonal pattern of the masks in FIGS. 11 and 12 has the advantage that in the coordinate system of the image recording means the parasitic contributions can be removed in both directions x, y of the image, as a modulation of the signal of interest is achieved in both directions.

In the following, an alternative way of the inventive demodulating method will be described using the concept of the Hilbert transformation.

A critical step of the image reconstruction is the translation of the signal of interest from the high frequency region (near the spatial frequency of the mask) towards the low frequency region after suppression of the low frequency contribution containing the parasitic light (thus step 2 as described above). The Hilbert transform is also suitable to operate this translation.

The Hilbert transform of a function is generally defined as:

$$\begin{matrix}\begin{matrix}\tilde{s} = ( h ⋆ s ) ( x , y ) \\ = {\int }_{- ∞}^{∞} s ( a , b ) . h ( x - a , y - b ) d a d b \\ = \frac{1}{Π} {\int }_{- ∞}^{∞} \frac{s ( a , b )}{( x , a ) . ( y , b )} d a d b\end{matrix} & ( equation 6 )\end{matrix}$$

Where

$$h ( x , y ) = \frac{1}{Π x} \cdot \frac{1}{Π y} \qquad ( equation 7 )$$

The Fourier transform of Hilbert's function f is defined as:

h(wₓ,w_{y})=(−i.sgn(wₓ))·(−i.sgn(wₓ))=−sgn(wₓ)·sgn(w_{y}) (equation 8)

Where

sng(w)=1 if w>0

sng(w)=0 if w=0

sng(w)=−1 if w<0 (equation 9)

The signal of interest modulated by the mask can be written as:

r(x,y)=s(x,y)·cos(2π(wₘₓx+w_{my}·y+φ)) (equation 10)

This corresponds to the spatial spectrum of the measured signal—the sum of the modulated signal of interest and the unmodulated parasitic signals—with the low frequency contributions set to 0 as explained above.

Assuming that the bandpass of s(x, y), thus the range of frequencies characteristic of the signal of interest in the Fourier space, is sufficiently small compared to the mask period the Hilbert transform of r can be written:

\tilde{r}(x,y)=s(x,y)·sin(2π(wₘₓx+w_{my}·y+φ)) (equation 11)

The complex analytical signal

rₐ(x,y)=r(x,y)+\tilde{ir}(x,y) (equation 12)

can be constructed by setting to zero all the negative frequencies of the spatial spectrum of r and by taking the inverse Fourier transform of this filtered spectrum, the real part of the inverse Fourier transform corresponding to r and the imaginary part corresponding to \tilde{r}. The modulus of this complex analytical signal calculated from the images r and \tilde{r} is then given as:

$$\vert {r}_{a} ( x , y ) \vert = \vert \begin{matrix}s ( x , y ) . cos ( 2 π ( {w}_{mx} x + {w}_{my} . y + ϕ ) ) + \\ i . s ( x , y ) . sin ( 2 π ( {w}_{mx} x + {w}_{my} . y + ϕ ) )\end{matrix} \vert \\ \vert {r}_{a} ( x , y ) \vert = \vert s ( x , y ) \vert ⋆ \vert {e}^{2 π ( {w}_{mx} x + {w}_{my} . y + ϕ )} \vert = \vert s ( x , y ) \vert \qquad ( equation 13 )$$

With this method, it is thus possible to reconstruct the image of interest without the need of an a priori knowledge about the mask. Thereby, the numerical analysis of the recorded image is facilitated. For more complicated modulation signals and signals of interest, it is again possible to represent them by a superposition of several sinusoidal functions.

The disclosed method and at the same time the disclosed imaging apparatus according to the third embodiment best function in case the signal of interest has a sufficiently short bandpass, like mentioned above, compared to the frequency of the mask.

As already discussed, different modulation masks can be used, like illustrated in FIGS. 10 to 12. The smaller the period of the modulation mask 55 the better the demodulation results will be. Practically the limit is given by the resolution of the image recording means, as one period should be covered by at least four pixels in case a CCD sensor is used. Indeed, if the spectrum corresponding to the parasitic signals and the spectrum of the signal of interest duplicated near the peak corresponding to the frequency of the mask are distant enough from each other in the spectral domain, one will be able to filter the totality of the parasitic signals without loosing information about the signal of interest.

Furthermore, the more negligible the secondary peaks of the modulation mask 55 in the spectral domain will be—see right side of FIGS. 10 to 12—the more favorable it is for the demodulation of the image recorded by the image recording means 59. In fact, with a pure sinusoidal modulation mask, the spatial spectrum of the image of interest will be duplicated only near one peak corresponding to the frequency of the mask. This will make the filtering of the recorded image easier as all the information of the signal of interest is concentrated in or around the one peak of the modulation mask. In contrast thereto with a binary mask (see FIG. 11) composed of transparent and black patterns which is a sum of sinusoidal waves, the spatial spectrum of the image of interest will be duplicated near each peak corresponding to an harmonic of the frequency of the binary modulation mask, and thus will make the filtering of the spectrum a bit more difficult and thus the reconstruction of the signal of interest less precise, but satisfying results are still achievable.

One way to achieve the grey level pattern is to photoplot small dots, typically black ink dots, on a transparent film, by varying the dot density. The minimum dot size, typically of the order of 20 μm in the photoplot technique, limits the number of grey levels and/or the minimum mask period. Depending on the application of the imaging apparatus according to the third embodiment, the decision can then be taken whether a grey scale pattern being more sinusoidal like or a binary mask with minimum period length is taken as modulation mask. Nevertheless modulation masks with higher resolution can of course be fabricated using other techniques than the photoplot method, which nevertheless is economically interesting.

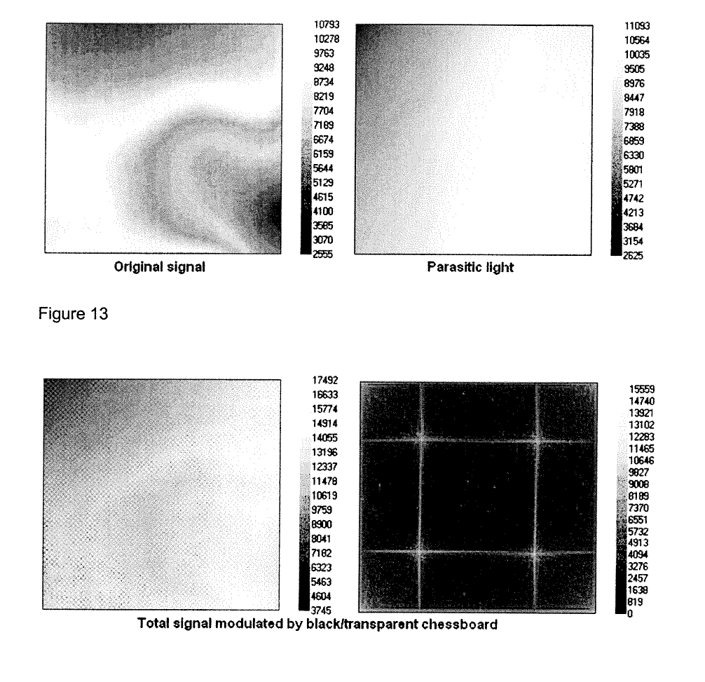

In the following, experimental results obtained with the imaging apparatus according to the third embodiment will be described. To carry out the experiments an imaging apparatus 51 like illustrated in FIG. 7 has been used in a dosimeter arrangement like shown in FIG. 2. The object 53 was illuminated with a light source being a large integration sphere providing white light. At the exit of the integration sphere, the illumination is homogeneous on a large surface. The original image, thus the signal of interest, was then produced by a semitransparent target with predefined features (see left picture in FIG. 13). It is observed across a polystyrene cube by a camera being at the same time the imaging means 57 and the image recording means 59. The polystyrene cube was used to ensure good quality images from the camera, because the imaging objective was optimized for this (dosimeter) configuration.

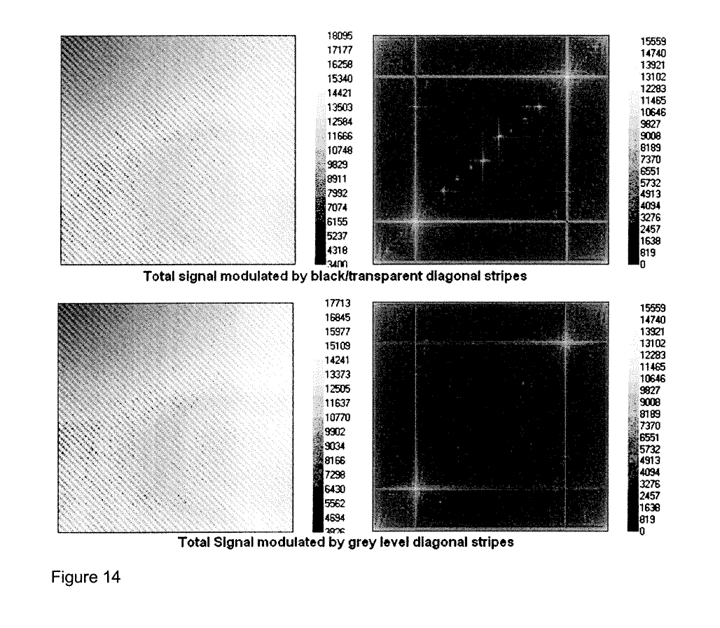

The signal of interest was first measured without modulation mask, left picture in FIG. 13. The parasitic contribution was numerically introduced, see right picture in FIG. 14. Then measurements were made using the three types of masks, as illustrated in FIGS. 10 to 12, directly positioned adjacent the object 53. The different measured images after parasitic light addition are illustrated in FIG. 14 (left side). The same data in the frequency space are also reported in the same FIG. 14 (right side). As expected, the “original image”, thus the signal of interest is split around four different frequency peaks in the case of the chessboard and only two for the diagonal stripes. The interest of the grey level mask is also apparent since residual information corresponding to harmonics of the mask frequency can be seen in the spatial spectrum for black/transparent stripes compared to grey level stripes.

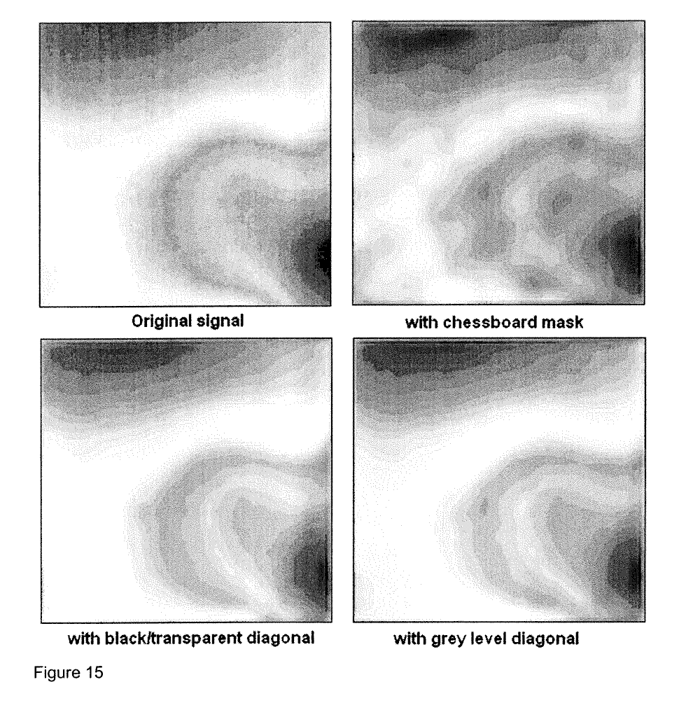

The image analysis based on the Hilbert method which was described in detail above, was then performed on the different images. The corresponding results are reported in FIG. 15 with the original image for comparison in the upper left corner.

It is obvious that the best results were achieved with the diagonal stripe masks. Nevertheless even with the checkerboard mask good results were achieved.

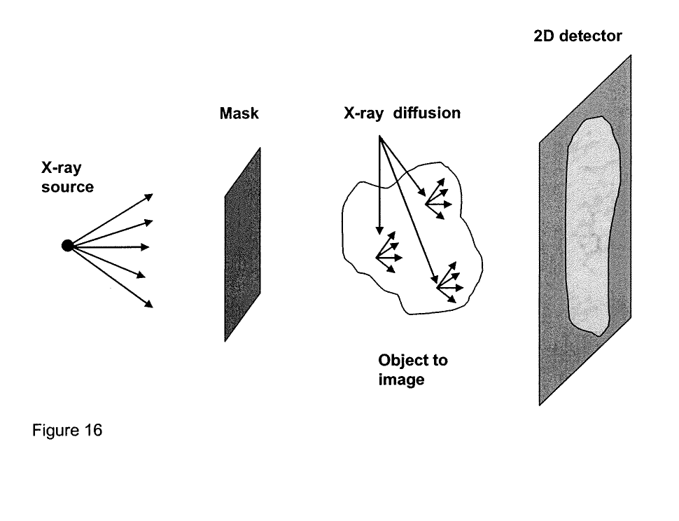

FIG. 16 illustrates a fourth embodiment of the disclosure, namely an imaging apparatus 91 according to the disclosure using x-rays as light source. If we shift to the x-ray domain in particular for x-ray radiography, there is no optics anymore and the imaging is made directly using only a quasi punctual X-ray source 93 and a suitable 2D detector image recording means 95.

It then becomes possible to spatially modulate the illumination beam by putting a periodic X-ray absorbing grid as modulating mask 97 at any place between the source and an object of interest 99. Like illustrated in FIG. 16, x-ray diffusion which is always a major drawback for x-ray imaging, occurs in the object of interest and leads to parasitic contributions that can be suppressed in exactly the same way as explained above in the context of the third embodiment by image analyzing means 61. The diffusion process is essentially a quasi isotropic process. So each pixel of the detector collects the light diffused by many points of the object of interest. The modulation of the beam is then completely spread out by this superposition and the diffused parasitic light is essentially unmodulated. This type of device can be useful for example for x-ray mammography.

We claim:

1. Device for discriminating Cerenkov and scintillation radiation, comprising periodically arranged first and second filters, having different relative absorption properties with respect to scintillation radiation and ionizing radiation.

2. Device for discriminating Cerenkov and scintillation radiation according to claim 1, wherein the first filters are transparent and the second filters are opaque to scintillation radiation.

3. Device for discriminating Cerenkov and scintillation radiation according to claim 1, wherein the first and second filters are transparent to ionizing radiation.

4. Device for discriminating Cerenkov and scintillation radiation according to claim 1, wherein the first and second filters are arranged in the form of a checkerboard.

5. Device for discriminating Cerenkov and scintillation radiation according to claim 1, wherein the first and second filters comprise a first layer and a second layer, and wherein the second layer comprises regions forming the second filters.

6. Device for discriminating Cerenkov and scintillation radiation according to claim 5, wherein the regions are square formed.

7. Device for discriminating Cerenkov and scintillation radiation according to claim 1, and further comprising a signal analyzing means configured to extract the scintillation radiation contribution out of a signal comprising scintillation and Cerenkov radiation.

8. Beam inspection device, comprising:
an inspection head comprising a scintillator and at least one ionizing radiation diffuser block,
a device for discriminating Cerenkov and scintillation radiation according to claim 1, and
an imaging system for forming an image from at least a part of the inspection head.

9. Beam inspection device according to claim 8, wherein the device for discriminating Cerenkov and scintillation radiation is positioned between the scintillator and the imaging system.

10. Beam inspection device according to claim 9, wherein the device for discriminating Cerenkov and scintillation radiation is positioned between the scintillator and an ionizing radiation diffuser block, arranged between the scintillator and the imaging system.

11. Beam inspection device according to claim 8, and further comprising an anti-re-excitation filter between the scintillator and the ionizing radiation diffuser block, arranged between the scintillator and the imaging system, and configured to absorb at least partially absorb Cerenkov radiation generated in the diffuser block.

12. Beam inspection device according to claim 8, and further comprising a Cerenkov radiation filter arranged between the ionizing radiation diffuser block, arranged between the scintillator and the imaging system, and the imaging system.

13. Beam inspection device according to claim 8, wherein the imaging system is protected against ionizing radiation using a lead shielding.

14. Beam inspection device according to claim 8, and comprising a second scintillator perpendicular to the first scintillator, at least one further ionizing radiation diffuser block, and a second imaging system which are arranged such that at the same time a depth dose profile and a beam profile at a given depth is detectable.

15. Radiotherapy device comprising beam inspection device according to claim 8.

16. Method for discriminating Cerenkov and scintillation radiation using a device for discriminating Cerenkov and scintillation radiation according to claim 1:
a) providing radiation comprising ionizing and scintillation radiation,
b) measuring the transmitted radiation having passed through the first and second filters, and
c) processing the measured signal to extract the scintillation radiation based on the spatially modulated amplitude of the transmitted radiation.

17. Method according to claim 16, wherein c) comprises processing based on Fourier transformation.

18. Method according to claim 16, wherein b) comprises providing a two dimensional image of the transmitted radiation and c) comprises extracting the scintillation radiation at each point of the image.

19. Imaging apparatus providing a means for reducing parasitic contributions from an image of an object, the apparatus comprising:
a spatial modulation mask for modulating a signal of interest in the real space, wherein the signal of interest is one of the signal illuminating the object or the signal emitted or reflected from the object, and
an image analyzing means configured to remove, at least partially, parasitic contributions added to the modulated signal of interest based on the shift of the signal of interest towards higher frequencies due to the modulation.

20. Imaging apparatus according to claim 19, wherein the modulation mask is a spatial modulation mask comprising a periodically arranged transmittance pattern.

21. Imaging apparatus according to claim 20, wherein the spatial modulation mask has a single spatial periodicity.

22. Imaging apparatus according to claim 20, and further comprising an image recording means, wherein the transmittance pattern of the spatial modulating mask is configured and arranged in a tilted way with respect to the coordinate system of the image recording means.

23. Imaging apparatus according to claim 20, wherein the transmittance pattern of the spatial modulating mask corresponds to a substantially binary pattern of alternating stripes of high and low transmission.

24. Imaging apparatus according to claim 20, wherein the transmittance pattern of the spatial modulating mask is a grey level pattern.

25. Imaging apparatus according to claim 20, wherein one period of the transmittance pattern of the spatial modulating mask covers at least one of four sensor elements or pixels of the image recording means.

26. Imaging apparatus according to claim 19, and further comprising imaging means and wherein the spatial modulation mask is placed one of in or close to the object plane of the imaging means such that in use the spatial modulation mask is placed between the position of an object to be imaged and the imaging means.

27. Imaging apparatus according to claim 26, wherein the spatial modulation mask is directly placed adjacent the object.

28. Imaging apparatus according to claim 19, wherein the modulation mask is placed between an X-ray source and the object to be imaged.

29. Method for reducing parasitic contributions from an image of an object, comprising:
a) modulating a signal of interest with a spatial modulating mask, wherein the signal of interest is one of the signal illuminating the object or the signal emitted or reflected from the object,
b) removing, at least partially, parasitic contributions added to the modulated signal of interest, based on the shift of the signal of interest towards higher frequencies due to the modulation.

30. Method according to claim 29, wherein b) comprises low pass filtering the spectral domain and demodulating the filtered signal into the spatial domain by one of inverse Fourier transformation, Hilbert transformation, or a combination thereof to thereby create the image signal free of parasitic contributions.

31. Method according to claim 30, wherein the main modulation frequency of the spatial modulation mask is higher than the spectral band of the signal of interest.

32. The device for discriminating Cerenkov and scintillation radiation according to claim 5, wherein the first layer is a plastic sheet.

33. The device for discriminating Cerenkov and scintillation radiation according to claim 32, wherein the plastic sheet is formed of one of polystyrene and Plexiglas.

34. The device for discriminating Cerenkov and scintillation radiation according to claim 7, wherein the signal analyzing means is further configured to extract the scintillation radiation contribution using a Fourier transform algorithm.

35. The imaging apparatus according to claim 22, wherein the tilted arrangement is diagonal.

36. The imaging apparatus according to claim 24, wherein the grey level pattern is a sinusoidal grey level pattern.

37. Radio therapy device comprising a device for discriminating Cerenkov and scintillation radiation according to claim 1.

38. Method for discriminating Cerenkov and scintillation radiation using a beam inspection device according to claim 8, comprising:
a) providing radiation comprising ionizing and scintillation radiation,
b) measuring the transmitted radiation having passed through the first and second filters, and
c) processing the measured signal to extract the scintillation radiation based on the spatially modulated amplitude of the transmitted radiation.

39. Method according to claim 38, wherein c) comprises processing based on Fourier transformation.

40. Method according to claim 38, wherein b) comprises providing a two dimensional image of the transmitted radiation and c) comprises extracting the scintillation radiation at each point of the image.
